(19) United States
(12) Patent Application Publication
(10) Pub. No.: US 2013/0141378 A1
(43) Pub. Date: Jun. 6, 2013

(54) ELECTRONIC DEVICE

(71) Applicant: Panasonic Corporation, Osaka (JP)

(72) Inventors: Naoto YUMIKI, Osaka (JP); Yusuke ADACHI, Osaka (JP); Akira KOGA, Osaka (JP); Masahiro INATA, Hyogo (JP); Ryo OKUMURA, Osaka (JP)

(73) Assignee: Panasonic Corporation, Osaka (JP)

(21) Appl. No.: 13/753,688

(22) Filed: Jan. 30, 2013

Related U.S. Application Data
(63) Continuation of application No. PCT/JP2012/003684, filed on Jun. 5, 2012.

(30) Foreign Application Priority Data
Jun. 7, 2011 (JP) 2011-126981

(51) Int. Cl. G06F 3/041

(52) U.S. Cl. CPC G06F 3/041
USPC 345/173

(57) ABSTRACT

An exemplary electronic device includes: a display section for displaying display information; a touch panel arranged on a display surface side of the display section; a display information position detection section for detecting a position of the display information displayed; a display control section for controlling a movement of the display information based on an operation by a user on the touch panel; a vibrating section for vibrating the touch panel; and a vibration control section for controlling a vibration pattern of the vibrating section. When the user operates the display information on the touch panel, the display control section controls the movement of the display information based on the position of the display information detected by the display information position detection section, and the vibration control section controls the vibrating section in association with the movement of the display information.

This is a continuation of International Application No. PCT/JP2012/003684, with an international filing date of Jun. 5, 2012, which claims priority of Japanese Patent Application No. 2011-126981, filed on Jun. 7, 2011, the contents of which are hereby incorporated by reference.

### BACKGROUND

1. Technical Field

The present disclosure relates to an electronic device capable of generating a vibration in response to a touch operation by a user.

2. Description of the Related Art

For electronic devices with touch panels provided on display screens, there are techniques known in the art for changing information displayed thereon in response to an operation performed by a user on the touch panel.

For example, Japanese Laid-Open Patent Publication No. 9-231004 discloses a technique for a page-forward operation for an information processing device.

### SUMMARY

The present disclosure provides an electronic device capable of presenting a tactile sensation in response to a touch operation by a user, where the tactile sensation is associated with information displayed on the screen.

An electronic device according to an embodiment includes: a display section for displaying display information; a touch panel arranged on a display surface side of the display section; a display information position detection section for detecting a position of the display information displayed; a display control section for controlling a movement of the display information based on an operation by a user on the touch panel; a vibrating section for vibrating the touch panel; and a vibration control section for controlling a vibration pattern of the vibrating section, wherein when the user operates the display information on the touch panel, the display control section controls the movement of the display information based on the position of the display information detected by the display information position detection section, and the vibration control section controls the vibrating section in association with the movement of the display information.

With the present disclosure, it is possible to present, to the user, various tactile sensations in association with information displayed on the touch panel in response to a touch operation by a user.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1 is a perspective view showing a general configuration of an electronic device according to an embodiment.

FIG. 2 is an exploded perspective view showing an electronic device according to an embodiment.

FIG. 3 is a cross-sectional view showing an electronic device according to an embodiment.

FIG. 4 is a block diagram showing an electronic device according to an embodiment.

FIG. 5 is a perspective view showing a first vibrating section according to an embodiment.

FIG. 6 is a perspective view showing a second vibrating section according to an embodiment.

FIGS. 7(a) and (b) are schematic diagrams each showing an example of a vibration pattern of a first vibrating section according to an embodiment.

FIG. 8A(a) is a schematic diagram showing an example of a driving voltage for a second vibrating section according to an embodiment, and (b) is a schematic diagram showing an example of a vibration pattern of a second vibrating section according to an embodiment.

FIG. 8B(a) is a schematic diagram showing an example of a driving voltage for a second vibrating section according to an embodiment, and (b) is a schematic diagram showing an example of a vibration pattern of a second vibrating section according to an embodiment.

FIG. 9 is a diagram showing an example of an operation screen of an electronic device according to an embodiment.

FIG. 10(a) to (c) are schematic diagrams showing a first slide touch operation of an electronic device according to an embodiment.

FIG. 11 is a timing diagram for a first slide touch operation of an electronic device according to an embodiment.

FIG. 12 is a flow chart showing a flow of a slide touch operation of an electronic device according to an embodiment.

FIG. 13 is a timing diagram for another slide touch operation of an electronic device according to an embodiment.

FIG. 14 is a flow chart showing a flow of another slide touch operation of an electronic device according to an embodiment.

FIG. 15(a) to (c) are schematic diagrams showing a second slide touch operation of an electronic device according to an embodiment.

FIG. 16(a) to (c) are schematic diagrams showing a third slide touch operation of an electronic device according to an embodiment.

FIG. 17(a) to (c) are schematic diagrams showing a fourth slide touch operation of an electronic device according to an embodiment.

FIG. 18(a) to (c) are schematic diagrams showing a fifth slide touch operation of an electronic device according to an embodiment.

FIG. 19 is a schematic diagram showing a file operation of an electronic device according to an embodiment.

FIG. 20 is a schematic diagram showing how a file is transmitted/received between electronic devices according to an embodiment.

### DETAILED DESCRIPTION

An embodiment will now be described in detail, referring to the drawings. Note however that unnecessarily detailed descriptions may be omitted. For example, detailed descriptions on what are well known in the art or redundant descriptions on substantially the same configurations may be omitted. This is to prevent the following description from becoming unnecessarily redundant, to make it easier for a person of ordinary skill in the art to understand.

Note that the present inventors provide the accompanying drawings and the following description in order for a person of ordinary skill in the art to sufficiently understand the present disclosure, and they are not intended to limit the subject matter set forth in the claims.

Japanese Laid-Open Patent Publication No. 9-231004, realizes a control operation for quickly moving the display information to an intended position or a control operation in which the amount of control is made variable during an information process (specifically, a control operation in which the amount of control is made variable in a scroll display control, a page-flip display control, or a cursor movement display control). Japanese Laid-Open Patent Publication No. 9-231004 fails to disclose a technique for transmitting a vibration to a finger of a user, and it cannot be said that it provides a user-friendly control.

The present disclosure provides an electronic device capable of presenting a tactile sensation in response to a touch operation by a user, where the tactile sensation is associated with information displayed on the screen.

### Embodiment 1

<General Configuration of Electronic Device>

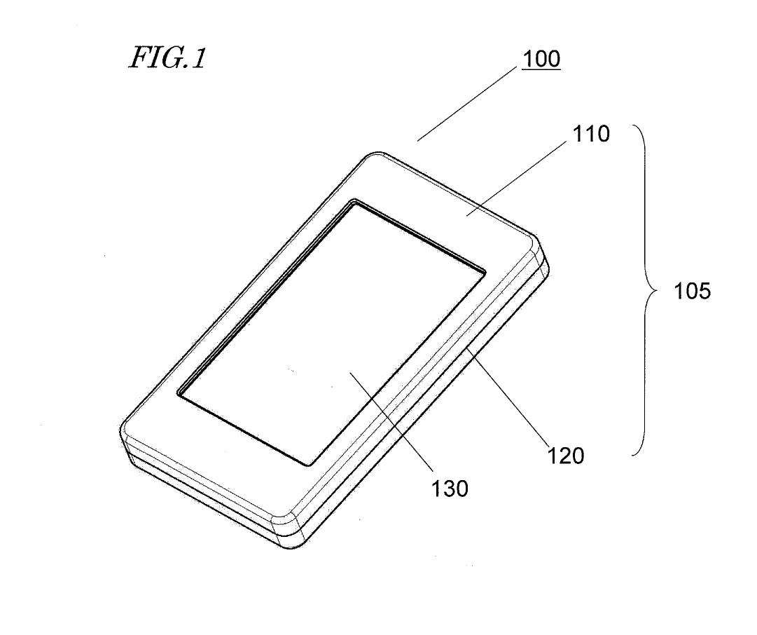

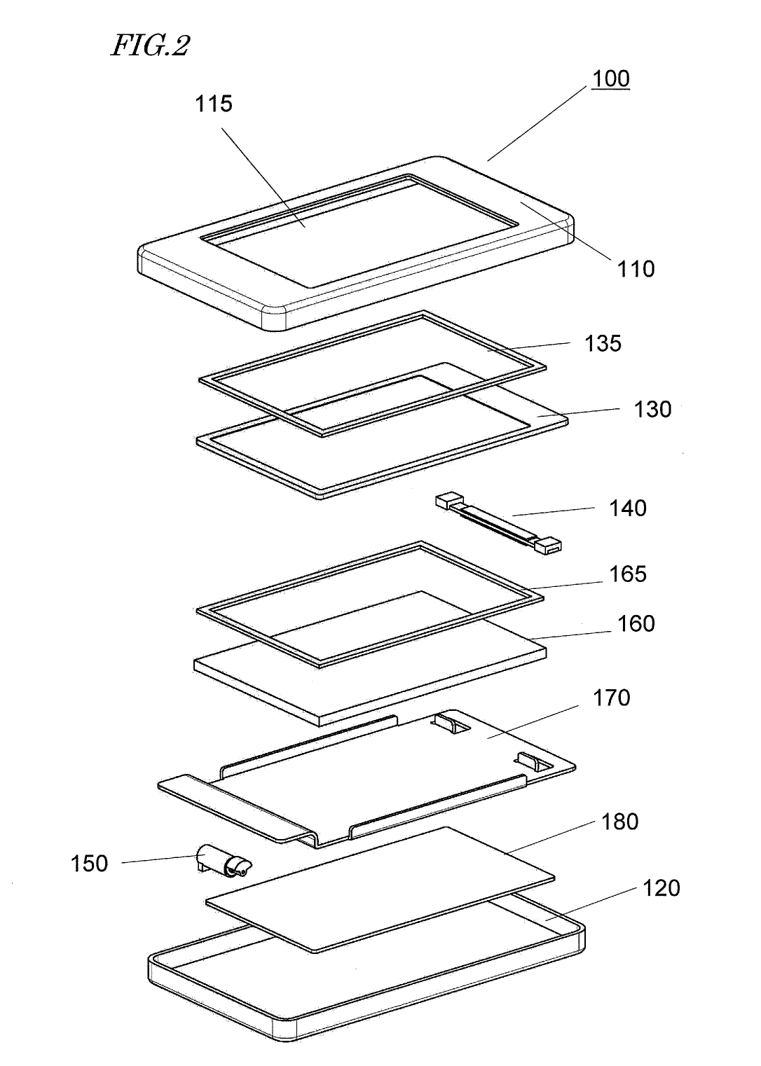

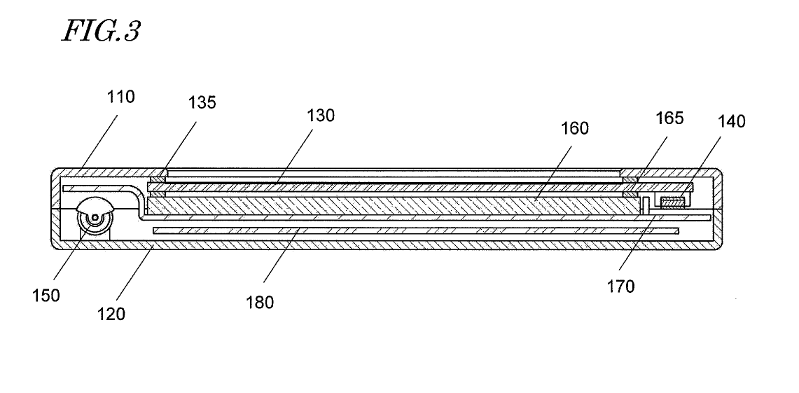

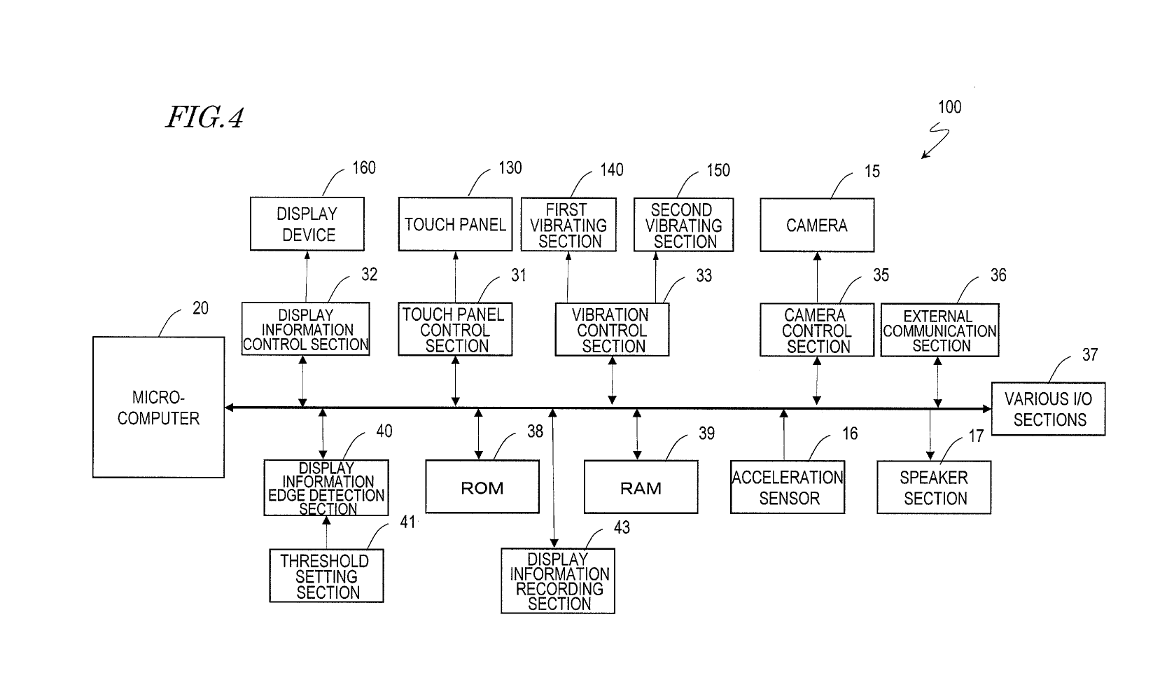

Referring to FIGS. 1 to 4, a general configuration of an electronic device according to an embodiment of the present disclosure will be described. FIG. 1 is a perspective view showing a general configuration of an electronic device 100 of the present embodiment. FIG. 2 is an exploded perspective view showing the electronic device 100 of the present embodiment. FIG. 3 is a cross-sectional view showing the electronic device 100 of the present embodiment. FIG. 4 is a block diagram showing the electronic device 100 of the present embodiment.

As shown in FIGS. 1 to 3, the electronic device 100 includes a display device 160, a touch panel 130 arranged on the display surface side of the display device 160 so as to cover the display device 160, a first vibrating section 140 for vibrating the touch panel 130, and a second vibrating section 150 for vibrating a lower casing 120.

A user operates the electronic device 100 by touching the touch panel 130, with a finger or a pen, on the content displayed on the display device 160.

An upper casing 110 and the lower casing 120 are integrally coupled together with a screw, or the like, thereby forming a casing 105 of the electronic device 100. The upper casing 110 has a display window 115, through which the touch panel 130 can be operated.

The first vibrating section 140 is attached to the touch panel 130, and by driving the first vibrating section 140, it is possible to vibrate the touch panel 130 and give a tactile sensation to the user.

A cushion material 135 is provided between the upper casing 110 and the surface of the touch panel 130 so that the vibration of the touch panel 130 is not directly transmitted to the upper casing 110.

The display device 160 is arranged on the surface of the touch panel 130 opposite to the surface thereof on the side of the upper casing 110, and a cushion material 165 is provided as described above so that the vibration of the touch panel 130 is not directly transmitted to the display device 160. The cushion materials 135 and 165 are shock-absorbing members of a silicon rubber, a urethane rubber, or the like, for example.

An image displayed on the display device 160 can be visually seen through the touch panel 130 from the side of the display window 115.

The display device 160 is attached to a frame 170, which is fixed to the lower casing 120, and is fixed inside the electronic device 100.

The second vibrating section 150 is attached to the lower casing 120. By driving the second vibrating section 150, the lower casing 120 is vibrated. As the lower casing 120 vibrates, it is possible to give tactile sensations to a user.

A circuit substrate 180 is attached to the lower casing 120, and the touch panel 130, the display device 160 and the first and second vibrating sections 140 and 150 are electrically connected thereto. The touch panel 130, the display device 160 and the first and second vibrating sections 140 and 150 are controlled by a microcomputer 20 provided on the circuit substrate 180.

Note that the touch panel 130 may be of an electrostatic type, a resistive type, an optical type, an ultrasonic type, an electromagnetic type, etc. The touch panel 130 is capable of detecting the touch position of a user. For its structure, the touch panel 130 is often attached to a glass plate, in which case the touch panel is defined to include the glass plate. The touch panel 130 is controlled by a touch panel control section 31. The microcomputer 20 can obtain information of the touch position of the user via the touch panel control section 31.

The display device 160 may be of a liquid crystal type, an organic EL type, an electronic paper type, a plasma type, etc. The display device 160 is controlled by a display information control section 32. The microcomputer 20 can present, to a user, an intended display by the display device 160 via the display information control section 32.

Note that while the touch panel 130 and the display device 160 are separated from each other in the present embodiment, the touch panel 130 and the display device 160 may be formed as an integral member. For example, an in-cell type touch panel may be employed where the touch panel function is integrated inside a liquid crystal panel, or an on-cell type touch panel may be employed where the touch panel function is integrated on the surface of a liquid crystal panel. Employing such a configuration, it is possible to further reduce the thickness and the weight.

As shown in FIG. 4, the electronic device 100 of the present embodiment includes the microcomputer 20, a ROM 38 for storing various programs, a RAM 39 for storing various data, the display device 160, the display information control section 32 for controlling the display device 160, the touch panel 130, the touch panel control section 31 for controlling the touch panel 130, a vibration control section 33 for controlling the first vibrating section 140 and the second vibrating section 150, a camera 15 for capturing an image, a camera control section 35 for controlling the camera 15, an acceleration sensor 16 for measuring the acceleration or the shock of the electronic device 100, a speaker section 17 for generating sound, an external communication section 36 responsible for communication with external units, a display information recording section 43 for recording display information, and various I/O sections 37 responsible for various other inputs and outputs. The external communication section 36 is connected while being authenticated for mutual connections between electronic devices, using a wireless LAN such as Wi-Fi (registered trademark), for example. The connection between electronic devices may be a connection via an external communication device such as an access point, or a P2P (wireless ad hoc network) connection, which is a direct connection with no external communication device therebetween. A display information edge detection section 40 detects an edge portion of display information displayed on the touch panel 130, and the detection position is set by a threshold setting section 41. Note that this threshold may be either a preset value or an arbitrary value determined by the user.

<Configuration of Vibrating Section>

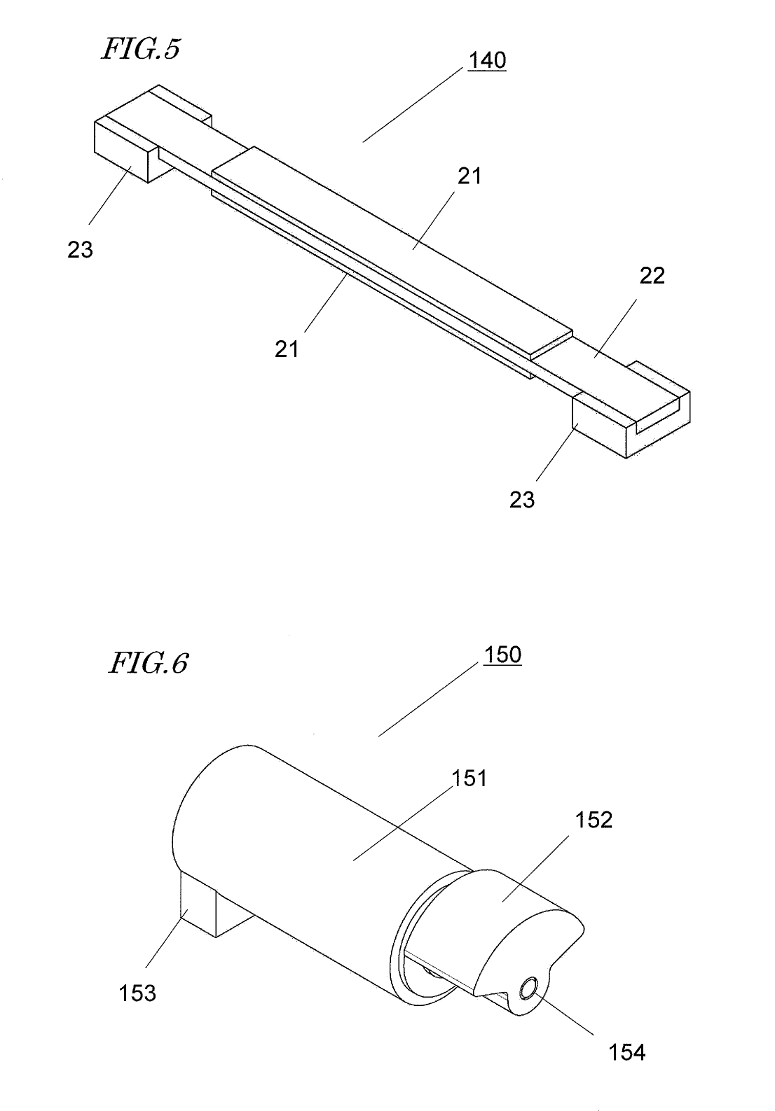

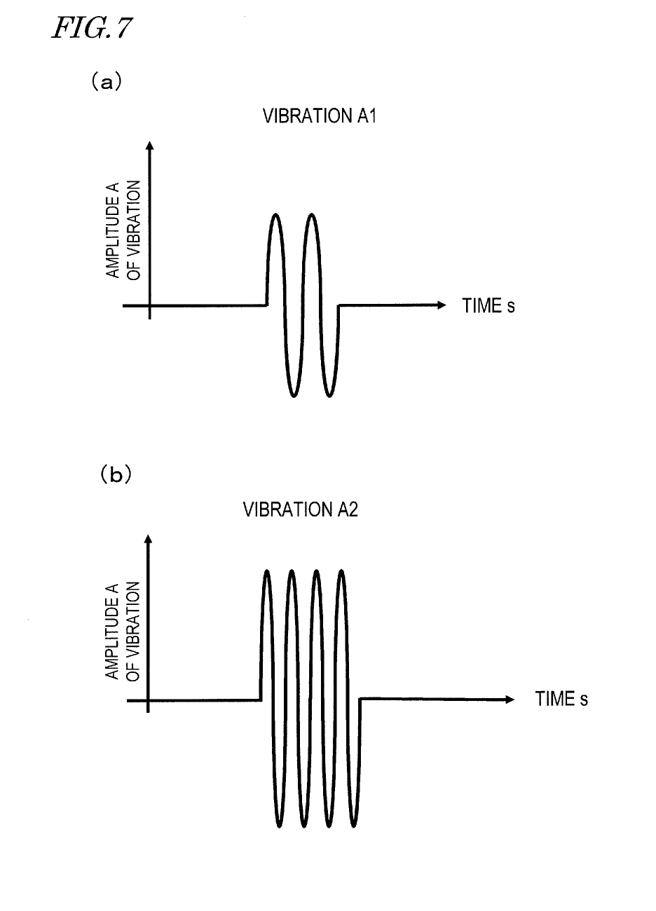

Next, referring to FIGS. 5 and 6, the configuration of the first and second vibrating sections 140 and 150 will be described. FIG. 5 is a perspective view showing the first vibrating section 140 of the present embodiment. FIG. 6 is a perspective view showing the second vibrating section 150 of the present embodiment.

As shown in FIG. 5, the first vibrating section 140 includes piezoelectric elements 21, a shim plate 22, and bases 23. The piezoelectric elements 21 are bonded on opposite sides of the shim plate 22. The piezoelectric element 21 is, for example, piezoelectric ceramic of lead zirconate titanate, or the like, or piezoelectric single crystal of lithium niobate, or the like. The opposite ends of the shim plate 22 are attached to the bases 23, thereby forming a so-called fixed-fixed structure. The bases 23 are attached to the touch panel 130. The piezoelectric elements 21 are stretched and shrunk by application of voltage from the vibration control section 33. For example, a control is performed such that one of the piezoelectric elements 21 attached on opposite sides of the shim plate 22 stretches while the other shrinks, thereby bending the shim plate 22. This can be alternately repeated, thereby generating a vibration.

The shim plate 22 is, for example, a spring member of phosphor bronze, etc. The vibration of the shim plate 22 vibrates the touch panel 130 via the bases 23. A user operating the touch panel 130 can feel the vibration of the touch panel 130 by touching the touch panel 130.

The bases 23 are, for example, a metal such as aluminum or brass, or a plastic such as PET or PP.

The frequency, amplitude and cycle of vibration are controlled by the vibration control section 33. The frequency of vibration is, for example, about 100 to 400 Hz.

While the piezoelectric elements 21 are attached to the shim plate 22 in the present embodiment, the piezoelectric elements 21 may be attached directly to the touch panel 130. Alternatively, a thin-film transparent piezoelectric member may be formed on the touch panel 130 by method such as sputtering, and used as the first vibrating section 140. Where a cover member, or the like, is present on the touch panel 130, the piezoelectric elements 21 may be attached to the cover member.

While the present embodiment employs a fixed-fixed structure where the opposite ends of the shim plate 22 are supported by the bases 23, it may employ a cantilever structure where only one end of the shim plate 22 is supported by the base 23.

As shown in FIG. 6, the second vibrating section 150 includes a DC motor 151, an eccentric weight 152, and a support section 153. The DC motor 151 is attached to the support section 153, and the support section 153 is attached to the lower casing 120.

The eccentric weight 152 is attached to the tip of a rotating shaft 154 of the DC motor 151. When a driving voltage is applied to the DC motor 151, the eccentric weight 152 attached to the rotating shaft 154 rotates. The rotary motion of the eccentric weight 152 generates a vibration.

The vibration from the DC motor 151 vibrates the lower casing 120 via the support section 153. A user operating the electronic device 100 can feel the vibration of the casing 105 of the electronic device 100 when a user is holding the electronic device 100 with one hand, for example.

The support section 153 is a shock-absorbing member of a plastic such as PET or PP, a silicon rubber, a urethane rubber, etc., for example.

<Description of Vibration Pattern>

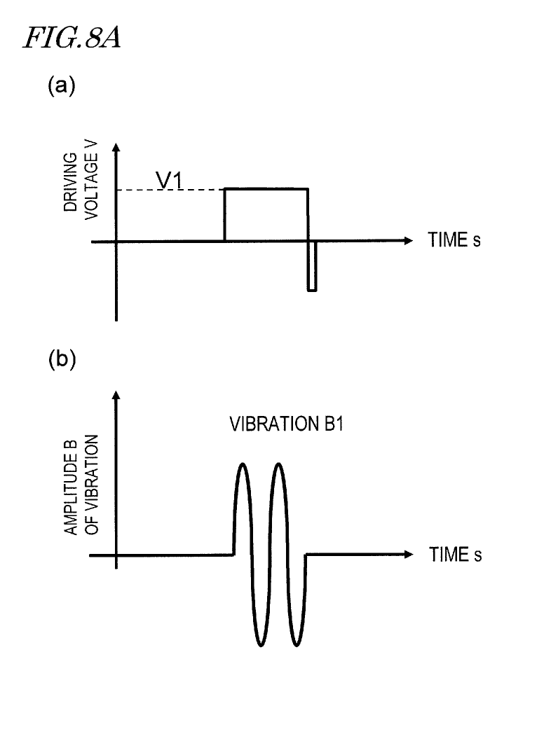

FIG. 7 is a schematic diagram showing an example of a vibration pattern of the first vibrating section 140.

In response to an instruction from the microcomputer 20, the vibration control section 33 applies a voltage to the first vibrating section 140 to vibrate the touch panel 130 with the amplitude shown in FIG. 7(a), thereby giving a user vibration A1. The voltage for generating vibration A1 is a sinusoidal wave of 150 Hz, 70 V (RMS) and 2 cycles, for example. Then, the amplitude on the touch panel 130 is about 5 μm. The vibration control section 33 applies a voltage to the first vibrating section 140 to vibrate the touch panel 130 with the amplitude shown in FIG. 7(b), thereby giving a user vibration A2. The voltage for generating vibration A2 is a sinusoidal wave of 300 Hz, 100 V (RMS) and 4 cycles, for example. Then, the amplitude on the touch panel 130 is about 15 μm. The frequency, the voltage and the sinusoidal wave are merely illustrative, and it may be a different waveform such as a square wave or saw-tooth wave, an intermittent waveform, or a waveform whose frequency or amplitude changes continuously. Note that by setting the frequency and the voltage so that the amplitude on the touch panel 130 is about 5-50 μm, it is possible to present a tactile sensation (vibration) that feels comfortable on a finger of a person.

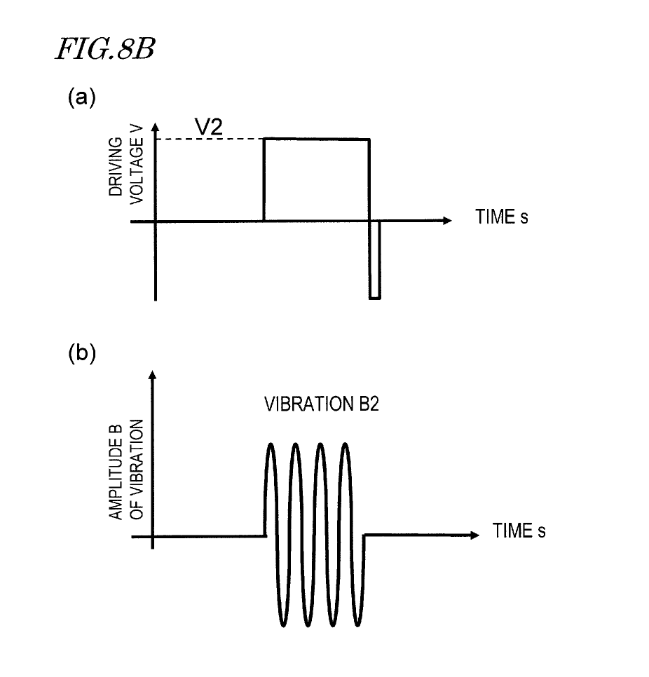

FIGS. 8A and 8B are schematic diagrams each showing an example of a vibration pattern of the second vibrating section 150.

In response to an instruction from the microcomputer 20, the vibration control section 33 applies voltage V1 as shown in FIG. 8A(a) to the second vibrating section 150. Thus, the DC motor 151 rotates. In order to stop the rotation, a voltage obtained by reversing voltage V1 can be applied so as to brake the rotation. A vibration is generated as the eccentric weight 152 shown in FIG. 6 rotates about the rotating shaft 154, thereby giving vibration B1 shown in FIG. 8A(b) to a user.

The vibration control section 33 applies voltage V2 shown in FIG. 8B(a) which is greater than voltage V1 to the second vibrating section 150. Thus, the DC motor 151 rotates. In order to stop the rotation, a voltage obtained by reversing voltage V2 can be applied so as to brake the rotation. A vibration is generated as the eccentric weight 152 shown in FIG. 6 rotates about the rotating shaft 154, thereby giving vibration B2 shown in FIG. 8B(b) to a user. Since the speed of the DC motor 151 is higher with vibration B2 than that with vibration B1, vibration B2 gives a user a vibration with a higher frequency than vibration B1.

Note that the waveforms of the voltages applied to the DC motor 151 are merely illustrative, and it may be a different waveform such as a sinusoidal wave or a saw-tooth wave, an intermittent waveform, or a waveform whose frequency or amplitude changes continuously.

Note that with the configuration of the second vibrating section 150 in which the eccentric weight 152 is spun by the DC motor 151, it is possible to change the frequency of vibration by changing the rotation speed, but it is difficult to change the amplitude of vibration. In contrast, with the first vibrating section 140 including the piezoelectric elements 21, it is easy to change the amplitude of vibration by changing the value of the voltage applied to the piezoelectric elements 21. It is also easy to change the frequency of vibration by changing the frequency of the voltage applied to the piezoelectric elements 21. Thus, the first vibrating section 140 including the piezoelectric elements 21 can generate vibrations of various patterns, and can present, to a user, various tactile sensations associated with information displayed on the touch panel.

<Description of Slide Touch Operation>

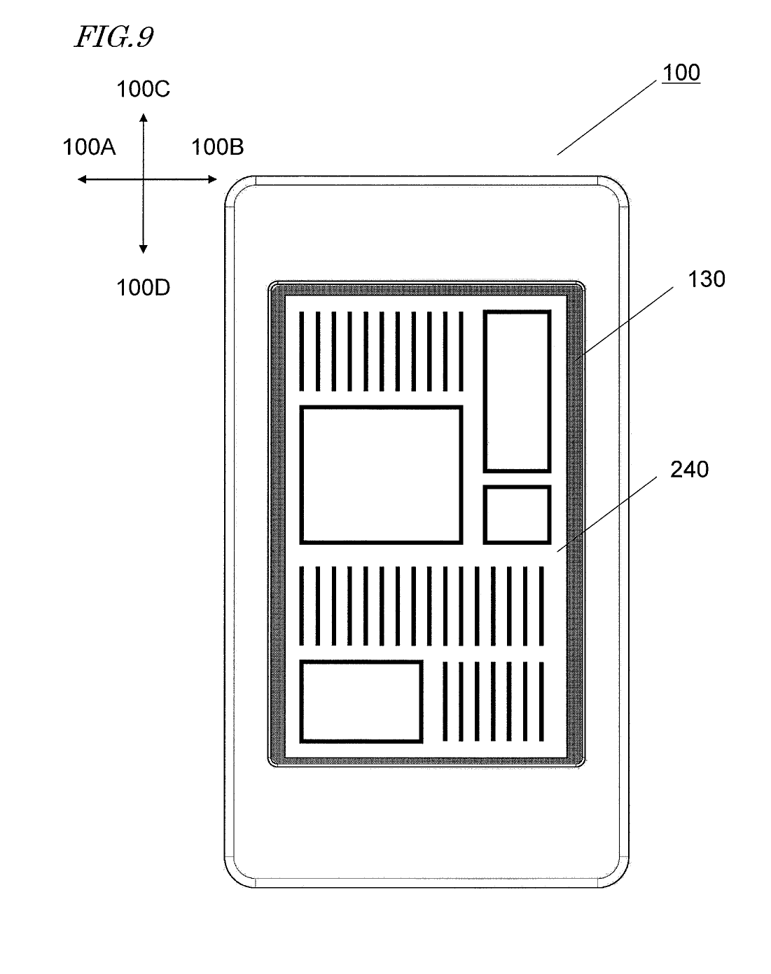

The slide touch operation used by a user operating the electronic device 100 will be described with reference to FIG. 9. FIG. 9 shows electronic newspaper, electronic book, or the like, as an example of an operation screen of the electronic device 100. Note that while the slide touch operation performed by a user will now be described assuming that the operation is performed with a finger, the means for input is not limited to a finger but the operation may be performed by using another member such as a pen.

The methods of operating the touch panel 130 with a finger generally include the operation of tapping the finger on the screen, the operation of double-tapping the finger on the screen, the operation of flicking the finger on the screen, the operation of moving the finger without lifting the finger off the screen, the operation of pinching two fingers together, and the operation of spreading two fingers apart. When operating display information such as electronic newspaper, the operation of moving a finger without lifting the finger off the screen is particularly suitable. Therefore, the present embodiment is configured so that it is possible to take advantage of that operation. Note that the operation of moving the finger without lifting the finger off the screen will hereinafter be referred to as the “slide touch operation”.

The slide touch operation by a user is an operation of touching the touch panel 130 with the finger, sliding the finger quickly in the up, down, left or right direction on the touch panel 130, and then lifting the finger off the touch panel 130 at an intended position. For example, the slide touch operation is used for flipping a page of electronic newspaper 240 displayed on the display device 160 as shown in FIG. 9. The directions in which the user performs the slide touch operation with a finger are herein defined as follows. On the touch panel 130, the right-to-left direction is denoted as 100A, the left-to-right direction as 100B, the down-to-up direction as 100C, and the up-to-down direction as 100D. For example, in order to display the next page of the electronic newspaper 240 (another page of the electronic newspaper 240 that is on the right of the current page), the user touches an arbitrary position of the electronic newspaper 240 with a finger, and then quickly slides the finger in the direction of the arrow 100A, thereby switching to the next page of the electronic newspaper 240. Conversely, in order to display the previous page, the user touches an arbitrary position of the electronic newspaper 240 with a finger, and then quickly slides the finger in the direction of the arrow 100B, thereby switching to the previous page of the electronic newspaper 240. Note that the slide touch operation for flipping to the next page may be performed in an upwardly diagonal direction within a certain angle with respect to the direction of the arrow 100C. Similarly, the operation of turning back to the previous page may be performed in a downwardly diagonal direction within a certain angle with respect to the direction of the arrow 100D.

<First Example Vibration Presented in First Slide Touch Operation>

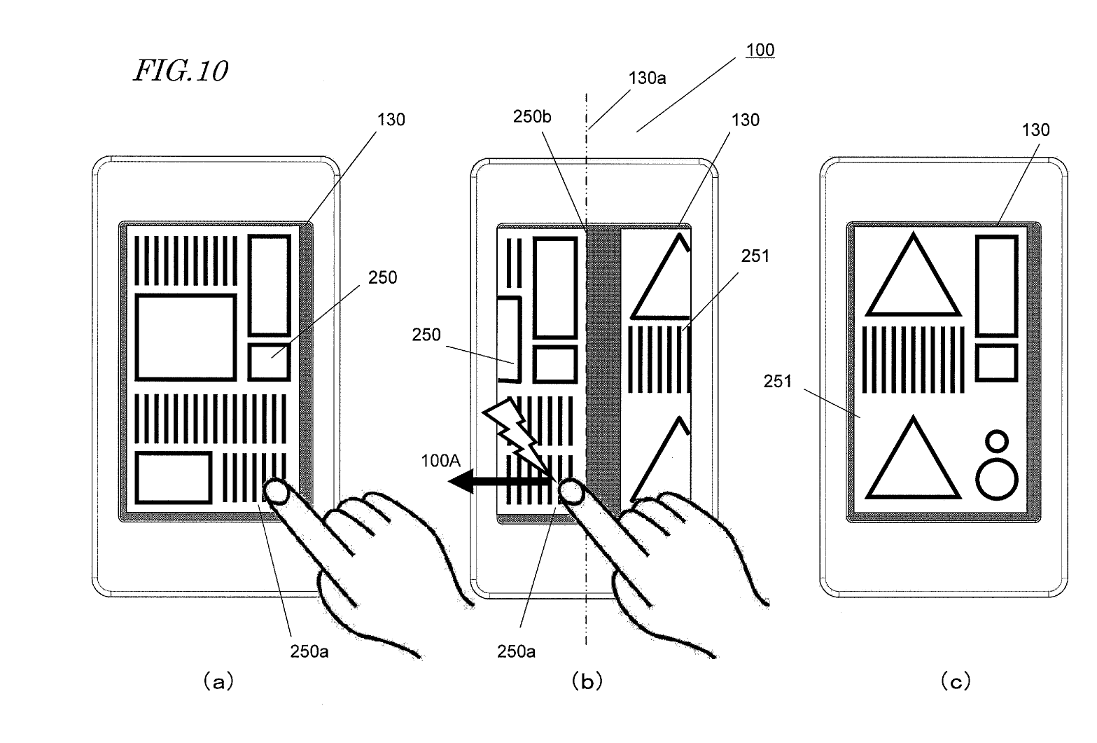

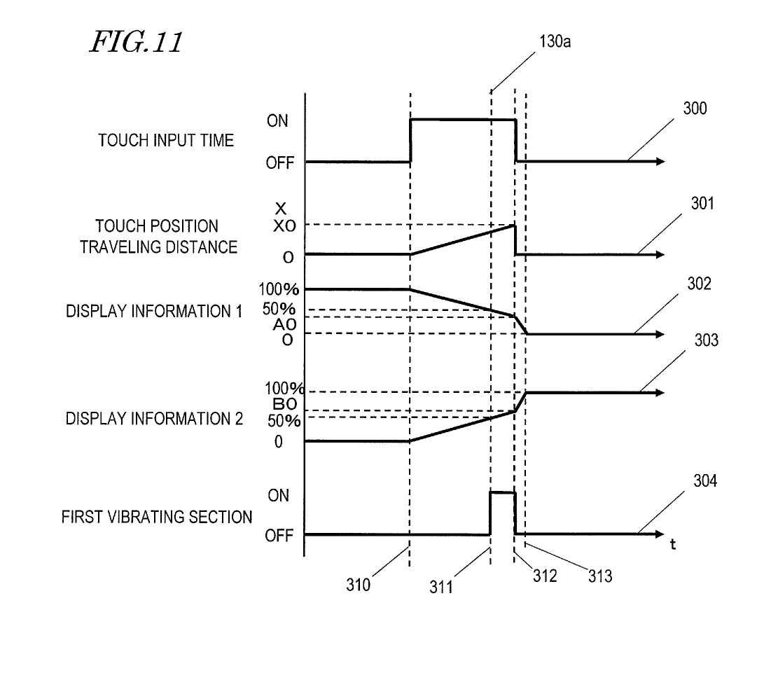

Referring now to FIGS. 10 and 11, the operation timing of the present embodiment will be described.

FIG. 10 is a schematic diagram showing a slide touch operation on the touch panel of the present embodiment. FIG. 11 is a timing diagram for a slide touch operation showing, from top to bottom, the touch input time, the touch position traveling distance, the display information 1, the display information 2, and the timing of driving the first vibrating section 140.

FIG. 10(a) shows a state where display information 250 is displayed in full screen on the touch panel 130. FIG. 10(b) shows a state where the user is performing a slide touch operation with a finger in the direction of the arrow 100A, whereby the page of the display information 250 is being passed forward, with the display information 251 of the next page being brought onto screen. FIG. 10(c) shows a state where the page-forward operation for the display information 250 has been completed, with the display information 251 being displayed in full screen.

Referring to FIG. 11, in the operation timing chart 300 for the touch input time, ON indicates that the user is touching the touch panel 130 and OFF indicates that the user is not touching the touch panel 130. As shown in FIG. 10(a), in the operation timing chart 301 for the touch position traveling distance, the position at which the user initially touches the touch panel 130 is indicated as origin (0), with X denoting the distance over which the user's finger has moved in the direction of the arrow 100A, and X0 denoting the position at which the user has lifted the finger off the touch panel 130. The operation timing chart 302 for the display information 1 represents the percentage of the area of the display information 250 being displayed with respect to the total area of the touch panel 130 (the total area of the display screen), with 100% being the state shown in FIG. 10(a) and 0% being the state shown in FIG. 10(c). That is, 100% is the state where the entirety of the display information 250 is displayed, and 0% is the state where none of the display information 250 is displayed. The operation timing chart 303 for the display information 2 represents the percentage of the area of the display information 251 being displayed with respect to the total area of the touch panel 130, with 0% being the state shown in FIG. 10(a) and 100% being the state shown in FIG. 10(c). The operation timing chart 304 for the first vibrating section 140 indicates whether the touch panel 130 is vibrating as a result of the vibration of the first vibrating section 140.

Referring to FIG. 11, with the slide touch operation of the present embodiment, the following operation is performed when the user touches the touch panel 130 with a finger.

At time 310, the user touches the touch panel 130. If the user moves the finger at a substantially constant velocity in the direction of the arrow 100A until time 311, the area of the display information 250 being displayed with respect to the total area of the touch panel 130 decreases while the area of the display information 251 of the next page being displayed increases. Note that the state at time 311 is the state shown in FIG. 10(b), where the display area of the display information 250 is about 50% with respect to the total area of the touch panel 130. Therefore, the right edge portion 250b of the display information 250 coincides with the generally central portion (the generally central portion of the display screen) 130a of the touch panel 130. In the present embodiment, the position of the central portion 130a is used as the threshold for determining whether the vibrating section 140 is to be vibrated, wherein the first vibrating section 140 is vibrated to vibrate the touch panel 130 when the right edge portion 250b of the display information 250 has moved past the threshold position, and the first vibrating section 140 is not vibrated otherwise. Note that the first vibrating section 140 may be vibrated at a point in time when the right edge portion 250b of the display information 250 reaches the position of the threshold.

Now, if the user continuously moves the finger in the direction of the arrow 100A, the first vibrating section 140 is vibrated to vibrate the touch panel 130, thereby transmitting the vibration to the finger of the user. Note that this vibration continues until the user lifts the finger off the touch panel 130 at time 312. When the user lifts the finger off the touch panel 130, the page-forward operation for the display information 250 is performed automatically, and the display information 251 of the next page is automatically displayed in full screen as shown in FIG. 10(c) at time 313.

In contrast, if the user lifts the finger off the touch panel 130 at such a position that the right edge portion 250b of the display information 250 is not past the threshold position (the position of the central portion 130a of the touch panel 130), the page-forward operation is not performed, and the display information 250 is displayed in full screen again as shown in FIG. 10(a).

Note that taking advantage of the piezoelectric elements 21 described above, the first vibrating section 140 may be vibrated while gradually increasing the amplitude thereof, the frequency thereof, or both, as the right edge portion 250b of the display information 250 moves past the threshold position. Then, the vibration is more likely to be perceived by the user. The waveform of vibration is not limited to a continuous waveform, but may be such a waveform that a vibration is repeatedly turned ON and OFF intermittently.

If the user inadvertently attempts to move back to the previous page while being on the first page, the second vibrating section 150 may be vibrated to vibrate the entire lower casing 120 so as to notify the user that the page change cannot be done, instead of passing the page of the display information backward. Similarly, if the user attempts to turn to the next page while being on the last page, the second vibrating section 150 may be vibrated to vibrate the entire lower casing 120 so as to notify the user that the page change cannot be done, instead of passing the page of the display information forward.

<Description of First Flow Chart of First Slide Touch Operation>

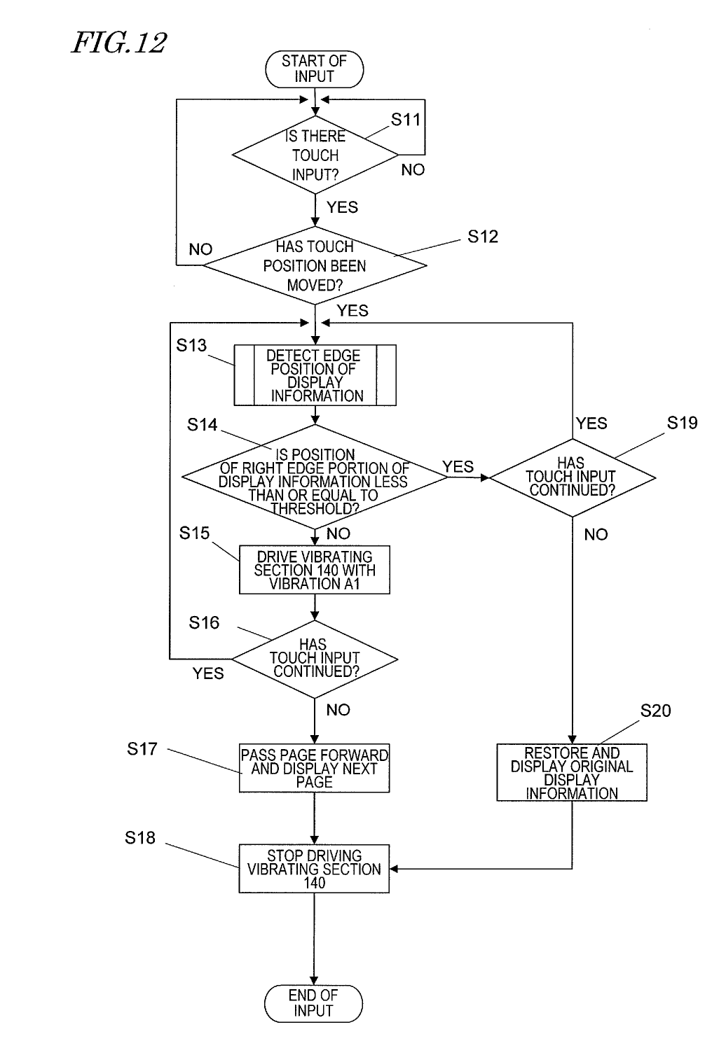

FIG. 12 is a flow chart showing the flow of the slide touch operation of the present embodiment. Note that steps will be abbreviated as “S”.

After the start of the input operation, in S11, based on information from the touch panel control section 31, the microcomputer 20 determines whether there is a touch input by a user on the touch panel 130. If the touch panel 130 is not being touched, the process waits until the touch panel 130 is touched again. FIG. 10(a) shows a state where there is a touch input by a user on the touch panel 130. If it is determined in S11 that there is a touch input, the process proceeds to S12. In S12, based on information from the touch panel control section 31, the microcomputer 20 determines whether there is a finger movement on the touch panel 130. If the microcomputer 20 determines that there is no finger movement on the touch panel 130, the process waits until there is a finger movement. Next, in S13, when the user performs a slide touch operation on the display information 250 in the direction of the arrow 100A as shown in FIG. 10(b), the display information edge detection section 40 detects the position, on the touch panel 130, of the right edge portion 250b of the display information 250. In this case, it is determined whether the position of the right edge portion 250b of the display information 250 has moved past the position which has been set by the threshold setting section 41. In S14, it is determined whether the right edge portion 250b of the display information 250 is less than or equal to the threshold, and the process proceeds to S19 if the determination result is YES. In contrast, if the threshold has been exceeded, the process proceeds to S15. In S15, the vibration control section 33 controls the first vibrating section 140, thereby giving vibration A1 to the user. Thus, with vibration A1, the user knows that a page-forward operation will be performed automatically if the user lifts the finger of at this position. In S16, it is determined whether the touch input by the user has continued. If so, the process returns to S13 while still giving vibration A1 through the vibrating section 140. In contrast, if it is determined that the touch input has discontinued, i.e., if the user has lifted the finger off the touch panel 130, the display information 250 is passed forward while the display information 251 of the next page is passed forward so as to be displayed in full screen on the touch panel 130 in S17, thereby transitioning to the state of FIG. 10(c). At the same time, in S18, the vibration control section 33 controls the first vibrating section 140 to stop vibration A1.

On the other hand, in S14, if the right edge portion 250b of the display information 250 has not moved past the threshold, the process proceeds to S19 to determine whether the touch input by the user has continued. If the touch input has continued, the process returns to S13 to again perform the display information edge position detection. If the touch input has not continued, i.e., if the user has lifted the finger off, the process proceeds to S20 so as to transition back to the state shown in FIG. 10(a) by restoring the state of the display information 250 to the original state. In S18, the vibration control section 33 controls the first vibrating section 140 to stop vibration A1, and the microcomputer 20 determines that the input operation by the user has ended.

Thus, in the present embodiment, when performing the slide touch operation for display information, a vibration is presented, whereby the user knows at which position the user can lift the finger off the touch panel so that the page-forward operation is performed automatically, thus improving the controllability. That is, the user knows through a tactile sensation that the finger is at such a position that the page-forward operation will be performed automatically if a vibration is presented to the user, and that the finger is not at such a position otherwise. Therefore, since the page-forward operation for the display information is not performed against the intention of the user, it is possible to provide an electronic device with excellent controllability.

<Second Example Vibration Presented in First Slide Touch Operation>

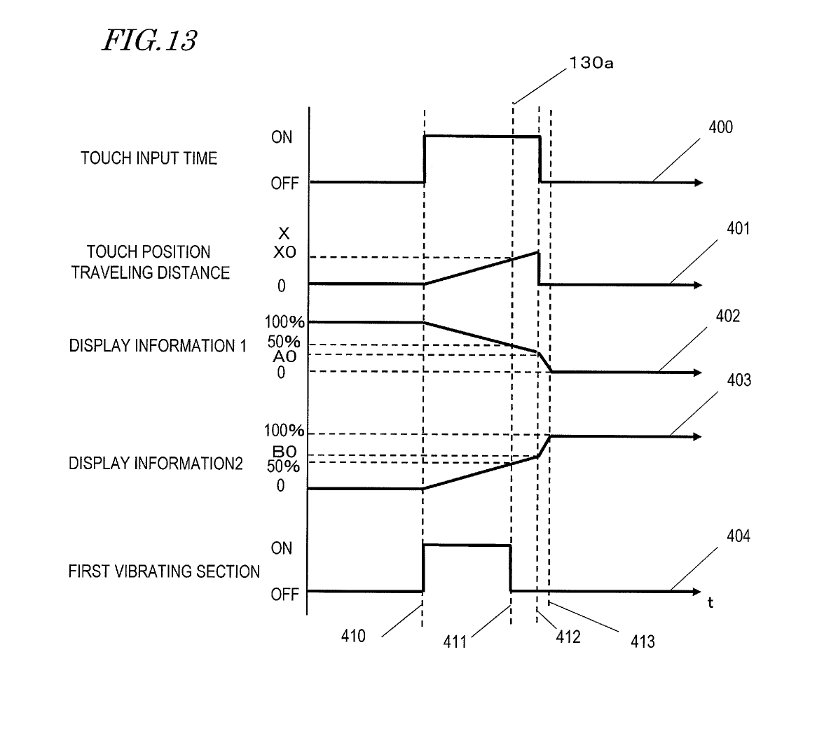

Referring now to FIGS. 10 and 13, another example of the operation timing of the present embodiment will be described.

FIG. 13 is a timing diagram for a slide touch operation showing, from top to bottom, the touch input time, the touch position traveling distance, the display information 1, the display information 2, and the timing of driving the first vibrating section 140.

Referring to FIG. 13, in the operation timing chart 400 for the touch input time, ON indicates that the user is touching the touch panel 130 and OFF indicates that the user is not touching the touch panel 130. As shown in FIG. 10(a), in the operation timing chart 401 for the touch position traveling distance, the position at which the user initially touches the touch panel 130 is indicated as origin (0), with X denoting the distance over which the user's finger has moved in the direction of the arrow 100A, and X0 denoting the position at which the user has lifted the finger off the touch panel 130. The operation timing chart 402 for the display information 1 represents the percentage of the area of the display information 250 being displayed with respect to the total area of the touch panel 130, with 100% being the state shown in FIG. 10(a) and 0% being the state shown in FIG. 10(c). The operation timing chart 403 for the display information 2 represents the percentage of the area of the display information 251 being displayed with respect to the total area of the touch panel 130, with 0% being the state shown in FIG. 10(a) and 100% being the state shown in FIG. 10(c). The operation timing chart 404 for the first vibrating section 140 indicates whether the touch panel 130 is vibrating as a result of the vibration of the first vibrating section 140.

Referring to FIG. 13, with the slide touch operation of the present embodiment, the following operation is performed when the user touches the touch panel 130 with a finger.

At time 410, when the user touches the touch panel 130, the first vibrating section 140 is vibrated to vibrate the touch panel 130, thereby presenting a vibration to the user. If the user moves the finger at a substantially constant velocity in the direction of the arrow 100A until time 411, the area of the display information 250 being displayed with respect to the total area of the touch panel 130 decreases while the area of the display information 251 of the next page being displayed increases. Note that the state at time 411 is the state shown in FIG. 10(b), where the display area of the display information 250 is about 50% with respect to the total area of the touch panel 130. Therefore, the right edge portion 250b of the display information 250 coincides with the generally central portion 130a of the touch panel 130. In the present embodiment, the position of the central portion 130a is used as the threshold for determining whether the vibrating section 140 is to be vibrated, wherein the first vibrating section 140 is vibrated to vibrate the touch panel 130 until the right edge portion 250b of the display information 250 coincides with the threshold position and the vibration of the first vibrating section 140 is stopped when the right edge portion 250b moves past the threshold position.

When the user continuously moves the finger in the direction of the arrow 100A, the vibration of the first vibrating section 140 stops, thereby stopping the presentation of the vibration to the finger of the user. When the user lifts the finger off the touch panel 130, the page-forward operation for the display information 250 is performed automatically, and the display information 251 of the next page is automatically displayed in full screen as shown in FIG. 10(c) at time 413.

In contrast, if the user lifts the finger off the touch panel 130 at such a position that the right edge portion 250b of the display information 250 is not past the threshold position (the position of the central portion 130a of the touch panel 130), the page-forward operation is not performed, and the display information 250 is displayed in full screen again as shown in FIG. 10(a).

Note that taking advantage of the piezoelectric elements 21 described above, the first vibrating section 140 may be vibrated while gradually increasing the amplitude thereof, the frequency thereof, or both, until the right edge portion 250b of the display information 250 coincides with the threshold position. Then, the vibration is more likely to be perceived by the user. The waveform of vibration is not limited to a continuous waveform, but may be such a waveform that a vibration is repeatedly turned ON and OFF intermittently.

Note that while the vibration of the first vibrating section 140 is stopped in this example when the right edge portion 250b of the display information 250 moves past the threshold position, the user may be otherwise notified that it has moved past the threshold position, for example, by varying the vibration, taking advantage of the piezoelectric elements 21 described above.

<Description of Second Flow Chart of First Slide Touch Operation>

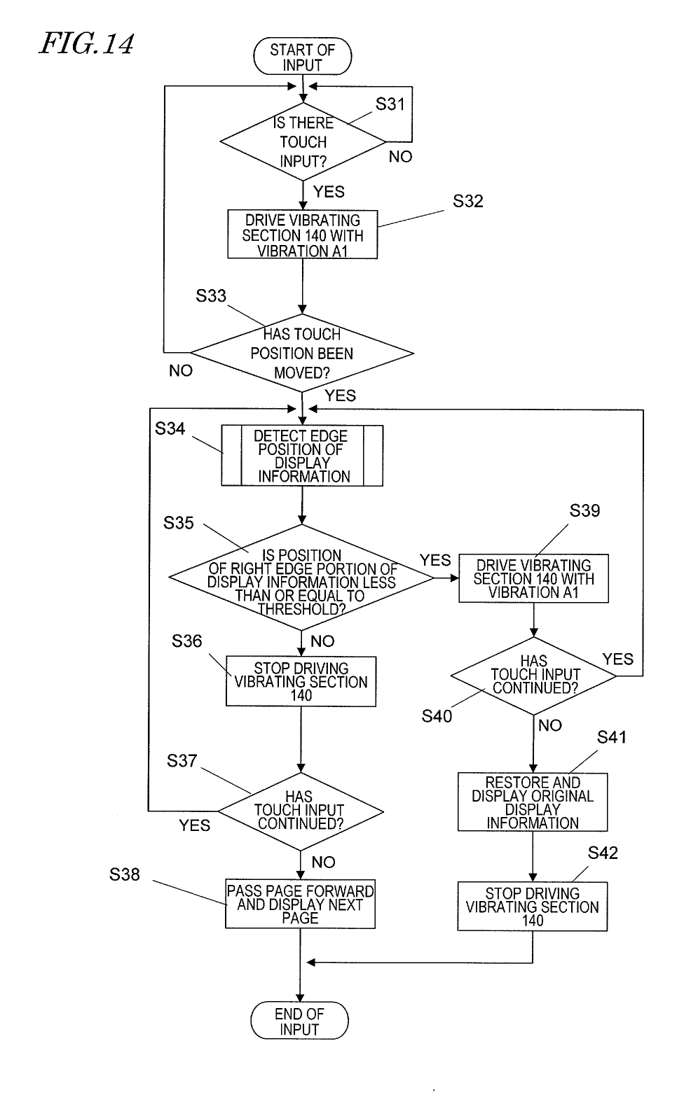

FIG. 14 is a flow chart showing the flow of the second slide touch operation. Note that steps will be abbreviated as “S”.

After the start of the input operation, in S31, based on information from the touch panel control section 31, the microcomputer 20 determines whether there is a touch input by a user on the touch panel 130. If the touch panel 130 is not being touched, the process waits until the touch panel 130 is touched again. FIG. 10(a) shows a state where there is a touch input by a user on the touch panel 130. If it is determined in S31 that there is a touch input, the process proceeds to S32. In S32, the vibration control section 33 controls the first vibrating section 140 so as to give vibration A1 to the user. In S33, based on information from the touch panel control section 31, the microcomputer 20 determines whether there is a finger movement on the touch panel 130. If the microcomputer 20 determines that there is no finger movement on the touch panel 130, the process waits until there is a finger movement. Next, in S34, when the user performs a slide touch operation on the display information 250 in the direction of the arrow 100A as shown in FIG. 10(b), the display information edge detection section 40 detects the position, on the touch panel 130, of the right edge portion 250b of the display information 250. In this case, it is determined whether the right edge portion 250b of the display information 250 has moved past the position which has been set by the threshold setting section 41. In S35, it is determined whether the position of the right edge portion 250b of the display information 250 is less than or equal to the threshold, and the process proceeds to S39 if the determination result is YES. In contrast, if the threshold has been exceeded, the process proceeds to S36. In S36, the vibration control section 33 controls the first vibrating section 140, thereby stopping vibration A1. Thus, as vibration A1 is stopped, the user knows that the page-forward operation will be performed automatically if the user lifts the finger off at this position. In S37, it is determined whether the touch input by the user has continued. If so, the process returns to S34. In contrast, if it is determined that the touch input has discontinued, i.e., if the user has lifted the finger off the touch panel 130, the display information 250 is passed forward while the display information 251 of the next page is passed forward so as to be displayed in full screen on the touch panel 130 in S38, thereby transitioning to the state of FIG. 10(c).

On the other hand, in S35, if the right edge portion 250b of the display information 250 has not moved past the threshold, the process proceeds to S39, where the vibration control section 33 controls the first vibrating section 140 so as to present vibration A1 to the finger of the user. Then, in S40, it is determined whether the user has continued the touch input. If the touch input has continued, the process returns to S34. In contrast, if the touch input has discontinued, i.e., if the user has lifted the finger off, the process proceeds to S41, thereby transitioning to the state shown in FIG. 10(a). In S42, the vibration control section 33 controls the first vibrating section 140 to stop vibration A1, and the microcomputer 20 determines that the input operation by the user has ended.

Thus, in the present embodiment, when performing the slide touch operation for display information, a vibration is presented, whereby the user knows at which position the user can lift the finger off the touch panel so that the page-forward operation is performed automatically, thus improving the controllability. That is, the user knows through a tactile sensation that the finger is at such a position that the page-forward operation is performed automatically if no vibration is presented to the user, and that the finger is not at such a position otherwise. Therefore, since the page-forward operation for the display information is not performed against the intention of the user, it is possible to provide an electronic device with excellent controllability.

<Schematic Operation Diagram of Second Slide Touch Operation>

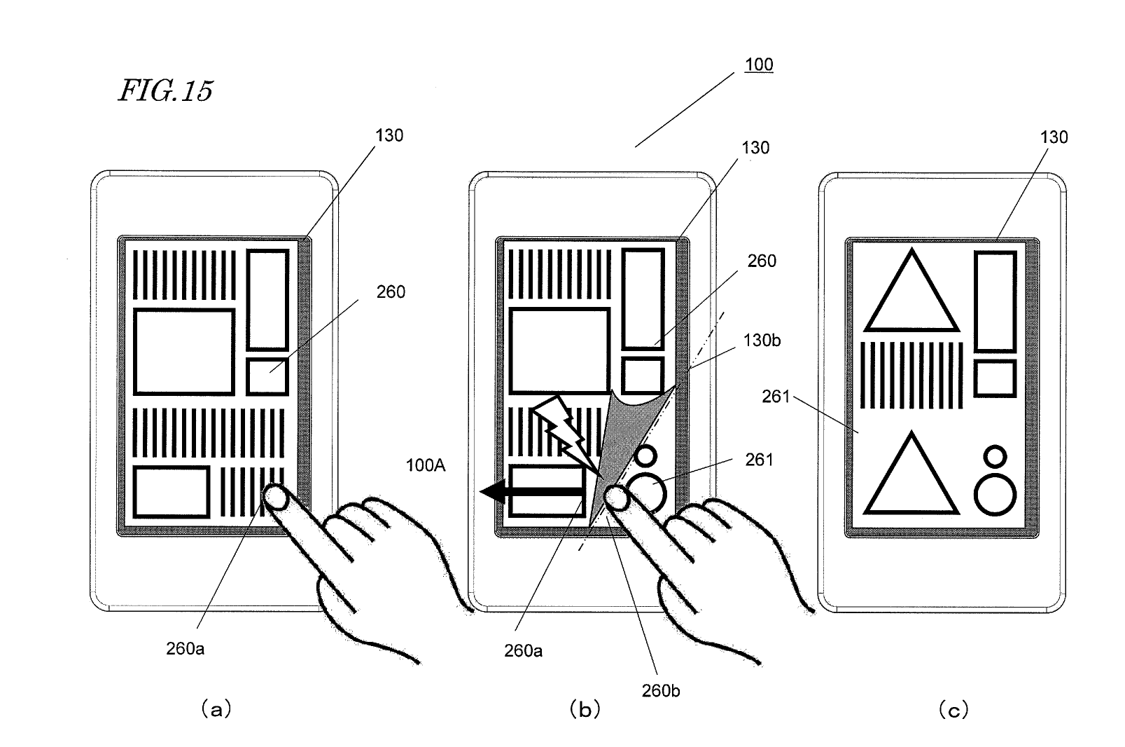

FIG. 15 is a schematic operation diagram of the second slide touch operation. As opposed to the first slide touch operation, the second slide touch operation is an operation performed as if the user were flipping a page.

FIG. 15(a) shows a state where display information 260 is displayed in full screen on the touch panel 130. FIG. 15(b) shows a state where the user is performing a slide touch operation with a finger, in the direction of the arrow 100A, on the lower right portion 260a of the display information 260, whereby the page of the display information 260 is being flipped over, with the display information 261 of the next page showing underneath the display information 260. FIG. 15(c) shows a state where the operation of flipping the page of the display information 260 has been completed, and the display information 261 is displayed in full screen. Also in this second slide touch operation, when the user lifts the finger off the touch panel 130, the page of the display information 260 is flipped over automatically so that the display information 261 of the next page is automatically displayed in full screen. Whether the page-flipping operation is performed automatically is determined based on whether the lower right edge portion 260b of the display information 260 has moved past the threshold position which has been set at the lower right section 130b of the touch panel 130. The page-flipping operation is automatically performed when the user lifts the finger off while the lower right edge portion 260b has moved past the threshold position. Note that with the second slide touch operation, as with the first slide touch operation, either one of the operations shown in the flow charts of FIGS. 12 and 14 can be used. Note that in the second slide touch operation, the portion of the page to be flipped over with the finger of the user is not limited to the lower right portion, but may also be the upper right portion.

<Schematic Operation Diagram of Third Slide Touch Operation>

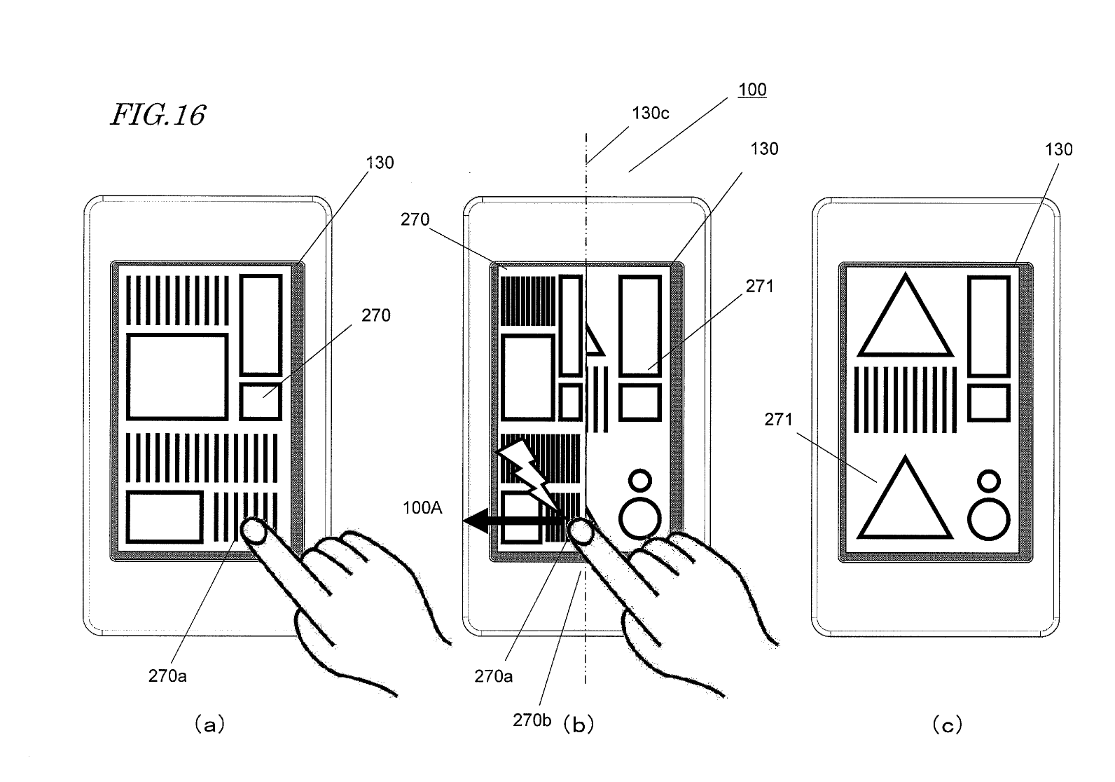

FIG. 16 is a schematic operation diagram of the third slide touch operation. As opposed to the first slide touch operation, the third slide touch operation is an operation of flipping a page as if the user were pulling a curtain open sideways.

FIG. 16(a) shows a state where display information 270 is displayed in full screen on the touch panel 130. FIG. 16(b) shows a state where the user is performing a slide touch operation with a finger, in the direction of the arrow 100A, on the right side portion 270a of the display information 270, whereby the page of the display information 270 is being flipped over, with the display information 271 of the next page showing underneath the display information 270. FIG. 16(c) shows a state where the operation of flipping the page of the display information 270 has been completed, and the display information 271 is displayed in full screen. Also in this third slide touch operation, when the user lifts the finger off the touch panel 130, the page of the display information 270 is flipped over automatically so that the display information 271 of the next page is automatically displayed in full screen. Whether the page-flipping operation is performed automatically is determined based on whether the right edge portion 270b of the display information 270 has moved past the threshold position which has been set at the central portion 130c of the touch panel 130. The page-flipping operation is automatically performed when the user lifts the finger off while the right edge portion 270b has moved past the threshold position. Note that with the third slide touch operation, as with the first slide touch operation, either one of the operations shown in the flow charts of FIGS. 12 and 14 can be used.

<Schematic Operation Diagram of Fourth Slide Touch Operation>

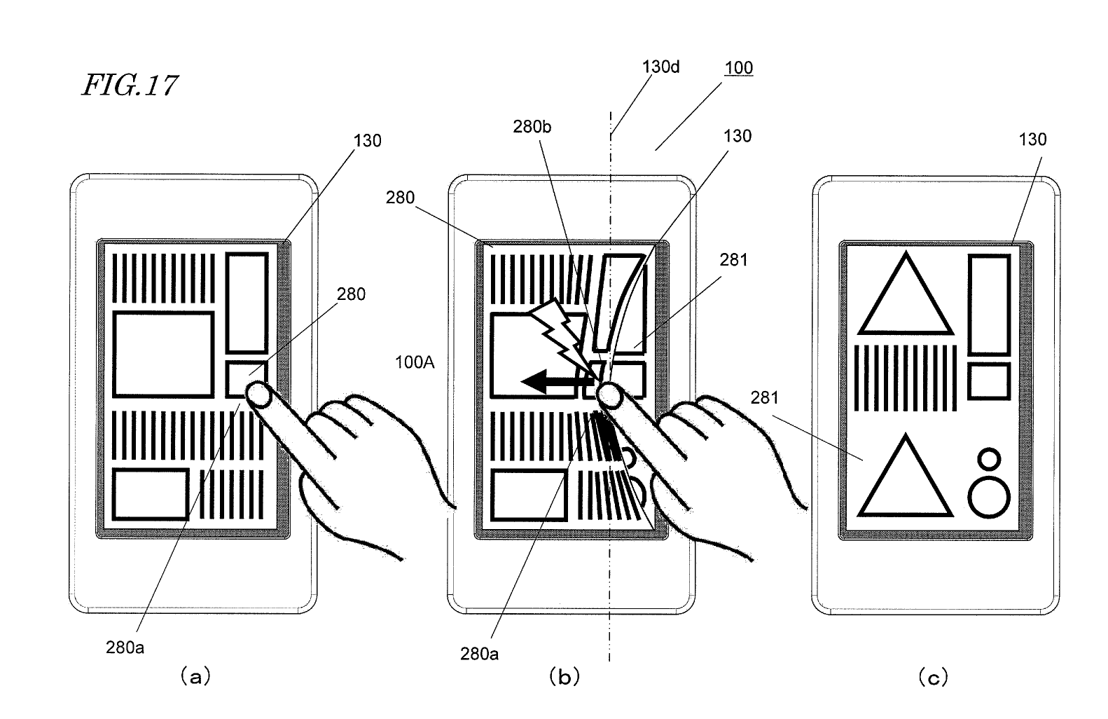

FIG. 17 is a schematic operation diagram of the fourth slide touch operation. As opposed to the first slide touch operation, the fourth slide touch operation is an operation of flipping a page as if the user were pulling the center of a curtain sideways.

FIG. 17(a) shows a state where display information 280 is displayed in full screen on the touch panel 130. FIG. 17(b) shows a state where the user is performing a slide touch operation with a finger, in the direction of the arrow 100A, on the right center portion 280a of the display information 280, whereby the page of the display information 280 is being flipped over, with display information 281 of the next page showing underneath the display information 280. FIG. 17(c) shows a state where the operation of flipping the page of the display information 280 has been completed, and the display information 281 is displayed in full screen. Also in this fourth slide touch operation, when the user lifts the finger off the touch panel 130, the page of the display information 280 is flipped over automatically so that the display information 281 of the next page is automatically displayed in full screen. Whether the page-flipping operation is performed automatically is determined based on whether the right center portion 280b of the display information 280 has moved past the threshold position which has been set at the right side portion 130d of the touch panel 130. The page-flipping operation is automatically performed when the user lifts the finger off while the right center portion 280b has moved past the threshold position. Note that with the fourth slide touch operation, as with the first slide touch operation, either one of the operations shown in the flow charts of FIGS. 12 and 14 can be used. Note that in the fourth slide touch operation, the portion of the page to be flipped over with the finger of the user is not limited to around the central portion, but may also be around the upper or lower edge.

<Schematic Operation Diagram of Fifth Slide Touch Operation>

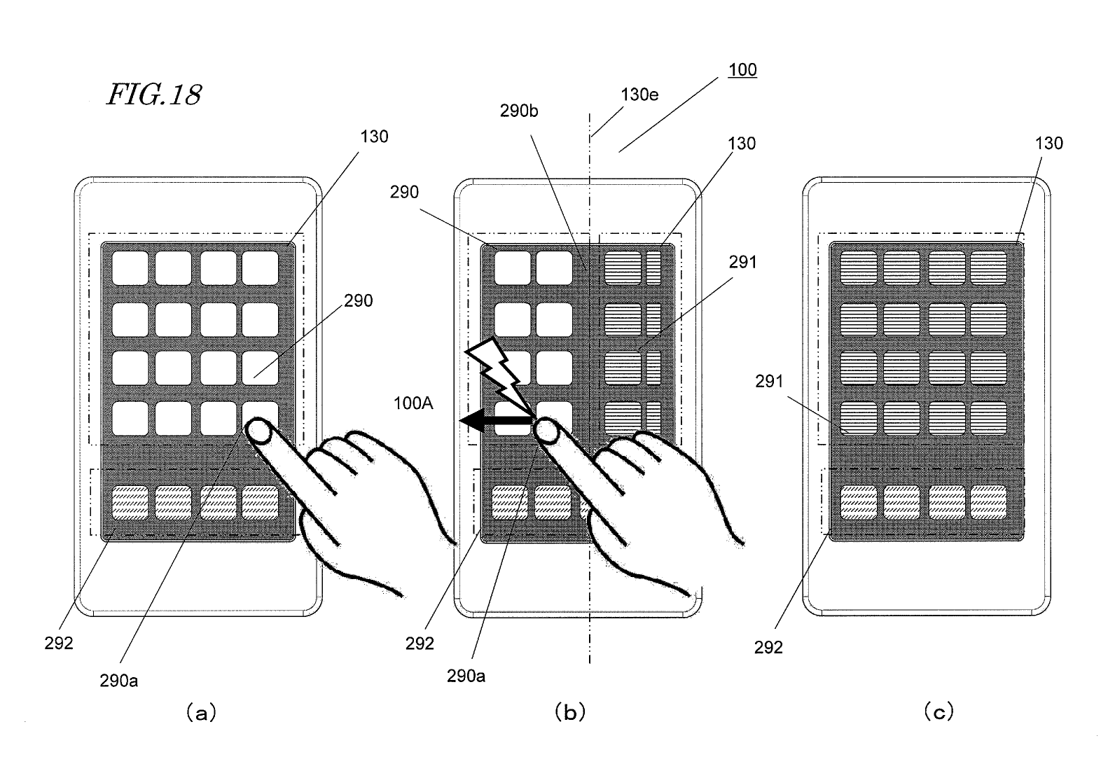

FIG. 18 is a schematic operation diagram of the fifth slide touch operation. As opposed to the first slide touch operation, the fifth slide touch operation is the page-forward operation for icons.

FIG. 18(a) shows a state where movable icon display information 290 and fixed icon display information 292 are displayed in full screen on the touch panel 130. FIG. 18(b) shows a state where the user is performing a slide touch operation with a finger in the direction of the arrow 100A on the lower right portion 290a of the icon display information 290, whereby the page of the icon display information 290 is being passed forward, with icon display information 291 of the next page being displayed on the right of the icon display information 290. FIG. 18(c) shows a state where the page-forward operation for the icon display information 290 has been completed, and the icon display information 291 and the fixed icon display information 292 are displayed in full screen. Also in the fifth slide touch operation, when the user lifts the finger off the touch panel 130, the page-forward operation for the icon display information 290 is performed automatically so that the icon display information 291 of the next page is automatically displayed in full screen. Whether the page-forward operation is performed automatically is determined based on whether the right edge portion 290b of the icon display information 290 has moved past the threshold position which has been set at the central portion 130e of the touch panel 130. The page-forward operation is automatically performed when the user lifts the finger off while the right edge portion 290b has moved past the threshold position. Note that with the fifth slide touch operation, as with the first slide touch operation, either one of the operations shown in the flow charts of FIGS. 12 and 14 can be used. Note that the direction in which the icon display information 290 is moved in the fifth slide touch operation is not limited to horizontal directions of the arrows 100A and 100B, but may also be vertical directions of the arrows 100C and 100D or a diagonal direction, for example.

Thus, in the present embodiment, when performing the slide touch operation for display information, a vibration is presented to the user, whereby the user knows at which position the user can lift the finger off the touch panel so that the page-forward operation is performed automatically, thus improving the controllability.

### Embodiment 2

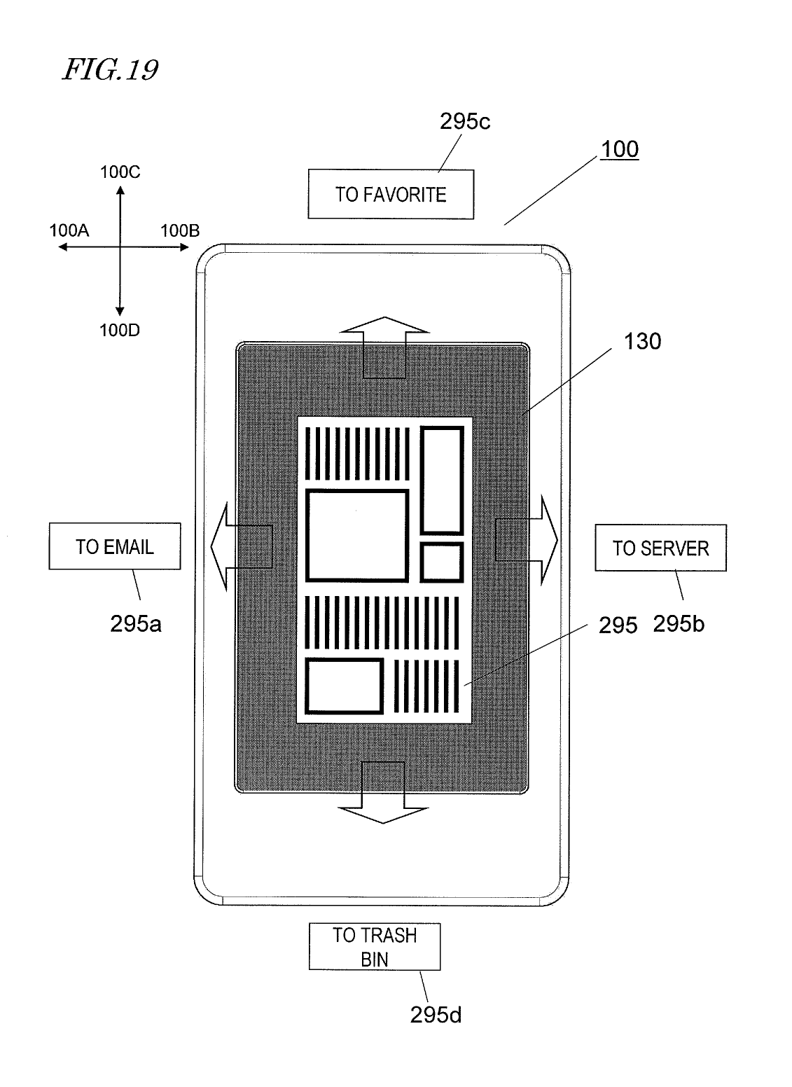

The slide touch operation for display information is not limited to the page-forward operation and the page-flipping operation described in Embodiment 1, and a tactile sensation may be given to the user when operating a file as shown in FIG. 19.

When the user performs the slide touch operation in the direction of the arrow 100A in order to send display information 295 to an electronic device of another user via email 295a using an external communication section 36, a tactile sensation may be presented to the user if data of the display information 295 is allowed to be transmitted. Alternatively, a tactile sensation may be presented to the user if the data is not allowed to be transmitted.

When the user performs the slide touch operation in the direction of the arrow 100B in order to send the display information 295 to a shared server 295b such as an electronic photo album using the external communication section 36, a tactile sensation may be presented to the user if data of the display information 295 is allowed to be uploaded. Alternatively, a tactile sensation may be presented to the user if the data is not allowed to be uploaded.

When the user performs the slide touch operation in the direction of the arrow 100C in order to place the display information 295 into a favorite folder of the display information recording section 43 in the electronic device, a tactile sensation may be presented to the user if data of the display information 295 is allowed to be placed in a favorite folder 295c. Alternatively, a tactile sensation may be presented to the user if the data is not allowed to be placed therein.

When the user performs the slide touch operation in the direction of the arrow 100D in order to delete the display information 295 by putting it into a trash bin 295d, a tactile sensation may be presented to the user if data of the display information 295 is allowed to be deleted. Alternatively, a tactile sensation may be presented to the user if the data is not allowed to be deleted. Note that for the operation of deleting the display information 295 by putting it into the trash bin 295d, a tactile sensation that is different from the other three operations may be presented to the user so as to differently warn the user of the deletion of a file.

Note that for the four-way slide touch operation performed on the electronic device, all of the four file operations may be implemented, or at least one of the four file operations may be implemented.

If only one file operation is implemented, the file operation can be implemented as follows, for example. In one file operation, the user can transmit email by performing a slide touch operation in the direction of the arrow 100A, and receive email by performing a slide touch operation in the opposite direction (the arrow 100B).

In one file operation, the user can upload data to a shared server by performing a slide touch operation in the direction of the arrow 100B, and download data from a shared server by performing a slide touch operation in the opposite direction (the arrow 100A).

In one file operation, the user can place data in a favorite folder by performing a slide touch operation in the direction of the arrow 100C, and take out data from a favorite folder by performing a slide touch operation in the opposite direction (the arrow 100D).

In one file operation, the user can put data into the trash bin by performing a slide touch operation in the direction of the arrow 100D, and restore data from the trash bin by performing the slide touch operation in the opposite direction (the arrow 100C).

By moving the position of the display information 295 in response to slide touch operations in the directions of the arrows 100A to 100D, the user can visually check the current state of operation. The user may be allowed to move the display information 295 in the slide touch operation so that the file operation may be performed automatically if the touch position moves past the threshold position, and the file operation may be canceled if the touch position does not move past the threshold position.

Note that the position of the display information 295 may be fixed, in which case a tactile sensation may be presented to the user when the slide distance (the touch position traveling distance) becomes greater than or equal to a predetermined distance.

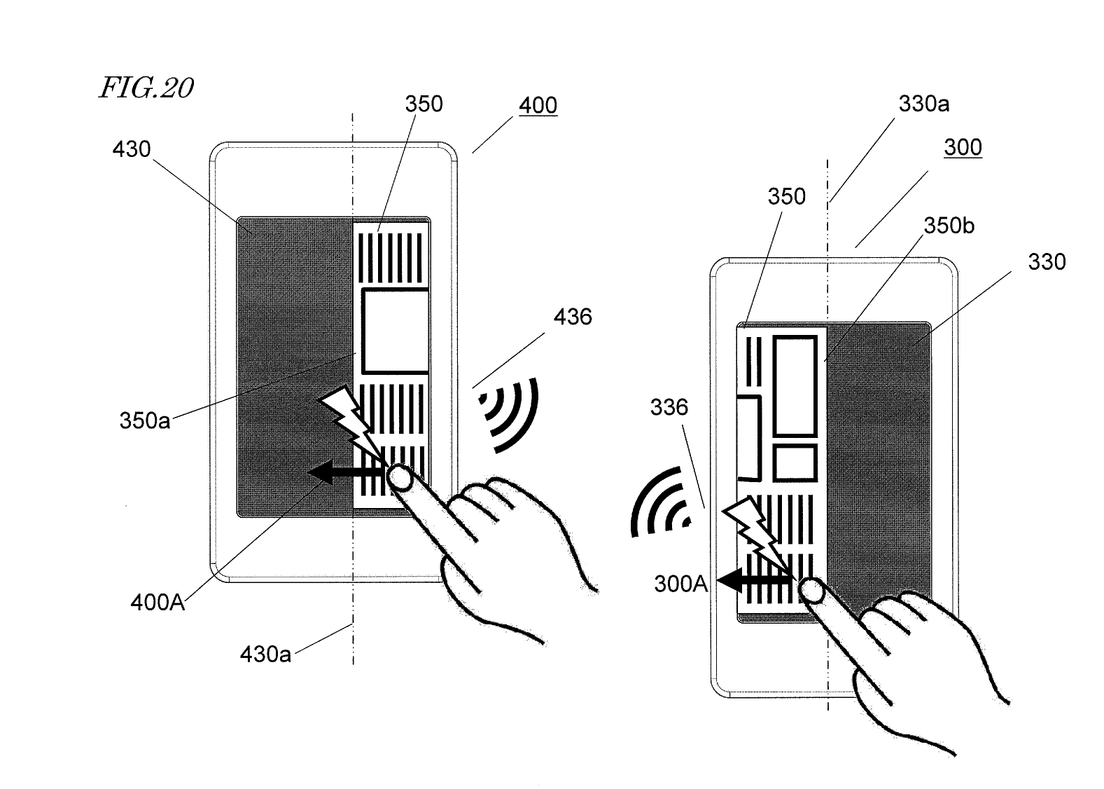

As a method of operation for electronic devices, a tactile sensation may be presented the user when exchanging files between electronic devices, as shown in FIG. 20.

Typically, where an external communication section 336 of an electronic device 300 and an external communication section 436 of an electronic device 400 are connected together via wireless or wired connection, and a file is transmitted from the electronic device 300 to the electronic device 400, a tactile sensation may be presented in response to the file operation as follows.

As the transmitting user performs a slide touch operation in the direction of the arrow 300A for display information 350 displayed on a touch panel 330 of the electronic device 300, data of the display information 350 can be transmitted. A vibration is generated if a right edge portion 350b of the display information 350 has moved to a position past a threshold position 330a, and if the user lifts the finger off the touch panel 330 at that position, the data is automatically transmitted to the electronic device 400. If the user lifts the finger off the touch panel 330 before moving the finger past the threshold position 330a, no vibration is generated and the data is not transmitted. Note that for file transmitting operations, the pattern of vibration may be varied when a particular file is transmitted or a file is transmitted to a particular electronic device or user, in which case the user can recognize, through a tactile sensation, that the user is executing a special operation.

As the receiving user performs a slide touch operation in the direction of the arrow 400A on a touch panel 430 of the electronic device 400, data of the display information 350 can be received. The user can drag the edge of the display information 350, and a vibration is generated when a left edge portion 350a of the display information 350 has moved to a position past a threshold position 430a, and if the user lifts the finger off the touch panel 430 at that position, the data can be received. If the user lifts the finger off the touch panel 430 before moving the finger past the threshold position 430a, no vibration is generated and the data is not received. Note that for file receiving operations, the pattern of vibration may be varied when a particular file is received or a file is received from a particular electronic device or user, in which case the user can recognize, through a tactile sensation, that the user is executing a special operation.

By providing visual display and presenting a tactile sensation as described above, users can easily perform file exchanging operations between their devices.

Note that the display information of the present embodiment is not limited to electronic newspaper and icons, but may also be a web page displayed by an Internet browser using the external communication section 36, email, a screen image of an SNS (Social Networking Service) site, an image captured by a camera 15, etc.

While information on the edge portion of display information is used, for the slide touch operation for display information, in making the threshold determination of whether the page-forward operation is performed automatically, the determination can be made alternatively based on the display area of the display information with respect to the total area of the touch panel, for example. In such a case, the display information edge detection section 40 may detect the area of the display information displayed on the screen, and a vibration may be generated as shown in FIG. 11 or a vibration may be stopped as shown in FIG. 13 when the value of the area becomes less than a predetermined threshold through the movement of at least a portion of the display information.

While at least a portion of the display information is moved in response to a slide touch operation by the user in the above description, a display information may be switched to another display information, irrespective of the distance over which the display information has been moved, when the slide touch operation is performed at a velocity greater than or equal to a predetermined velocity. By performing a page-forward operation even when the distance over which display information has been moved is small, if the page-flipping operation is performed at a high velocity, for example, it is possible to provide a smooth page-forward operation for the user. Also for operations illustrated in FIGS. 19 and 20, data may be transmitted/received, irrespective of the distance over which display information has been moved, if the slide touch operation is performed at a velocity greater than or equal to a predetermined velocity.

While a method for displaying display information has been described above for a case where the electronic device is in a portrait position, the display information may be rotated by 90 degrees when the electronic device is in a landscape position. The present disclosure is also applicable to a case where display information is displayed on an enlarged scale.

The strength and the frequency of vibration through which a tactile sensation is presented may be varied based on the direction of the slide touch operation.

Note that the operation of the electronic device described above may be implemented by means of hardware or software. A program implementing such a control operation is stored, for example, in an internal memory of the microcomputer 20 or in the ROM 38. Such a computer program may be installed onto the electronic device from a storage medium (an optical disc, a semiconductor memory, etc.) storing the computer program, or may be downloaded via a telecommunications network such as the Internet.

An electronic device 100 according to an embodiment includes: a display section 160 for displaying display information 250; a touch panel 130 arranged on a display surface side of the display section 160; a display information position detection section 40 for detecting a position of the display information displayed; a display control section 32 for controlling a movement of the display information based on an operation by a user on the touch panel; a vibrating section 140 for vibrating the touch panel; and a vibration control section 33 for controlling a vibration pattern of the vibrating section 140, wherein when the user operates the display information on the touch panel 130, the display control section 32 controls the movement of the display information based on the position of the display information detected by the display information position detection 40 section, and the vibration control section 33 controls the vibrating section 140 in association with the movement of the display information.

In one embodiment, the display information position detection section 40 detects an area of the display information displayed on the display section 160; and the vibration control section 33 vibrates the vibrating section 140 when a value of the area becomes less than a predetermined threshold as a result of a movement of a position of at least a portion of the display information.

In one embodiment, the display information position detection section 40 detects an area of the display information displayed on the display section 160; the vibration control section 33 starts vibrating the vibrating section 140 when the user starts operating the display information; and the vibration control section 33 changes the vibration of the vibrating section 140 when a value of the area becomes less than a predetermined threshold as a result of a movement of a position of at least a portion of the display information.

In one embodiment, the display information position detection section 40 detects a position of a predetermined portion of the display information; and the vibration control section 33 vibrates the vibrating section 140 when the predetermined portion of the display information has moved past a predetermined position as a result of a movement of a position of at least a portion of the display information.

In one embodiment, the display information position detection section 40 detects a position of a predetermined portion of the display information; the vibration control section 33 starts vibrating the vibrating section 140 when the user starts operating the display information; and the vibration control section 33 changes the vibration of the vibrating section 140 when the predetermined portion of the display information has moved past a predetermined position as a result of a movement of a position of at least a portion of the display information.

In one embodiment, the vibrating section 140 includes a piezoelectric element 21; the vibration control section 33 changes a vibration pattern of the vibrating section 140 in response to a movement of a position of at least a portion of the display information.

In one embodiment, the vibration control section 33 changes an amplitude of vibration of the vibrating section 140 in response to a movement of a position of at least a portion of the display information.

In one embodiment, the display section 160 switches the display information to another piece of display information in response to a movement of a position of at least a portion of the display information.

In one embodiment, when a velocity of a slide touch operation by the user on the touch panel 130 is greater than or equal to a predetermined velocity, the display section 160 switches the display information to the other piece of display information, irrespective of a distance over which at least a portion of the display information has been moved.

In one embodiment, the electronic device 100 further includes a communication section 36 for communicating with an external device, wherein the communication section 36 receives data associated with the display information from the external device to the electronic device 100 or outputs the data from the electronic device 100 to the external device, depending on a movement of a position of the display information.

An exemplary program of the present disclosure is a program for instructing an electronic device 100 to perform an operation of vibrating a touch panel 130, the program instructing the electronic device 100 to execute the steps of: detecting a position of display information displayed on the electronic device 100; controlling a movement of the display information based on an operation by a user on the touch panel 130; and when the user operates the display information on the touch panel 130, controlling the movement of the display information based on the detected position of the display information, and controlling the vibration of the touch panel 130 in association with the movement of the display information.

The present disclosure is applicable to an electronic device capable of generating a vibration in response to a touch operation by a user.

Embodiments have been described above as an illustration of the technique of the present disclosure. The accompanying drawings and the detailed description are provided for this purpose. Thus, elements appearing in the accompanying drawings and the detailed description include not only those that are essential to solving the technical problems set forth herein, but also those that are not essential to solving the technical problems but are merely used to illustrate the technique disclosed herein. Therefore, those non-essential elements should not immediately be taken as being essential for the reason that they appear in the accompanying drawings and/or in the detailed description.

The embodiments above are for illustrating the technique disclosed herein, and various changes, replacements, additions, omissions, etc., can be made without departing from the scope defined by the claims and equivalents thereto.

What is claimed is:

1. An electronic device comprising:
a display section for displaying display information;
a panel to be touched by a user;
a display information position detection section for detecting a position of the display information displayed;
a display control section for controlling a movement of the display information based on an operation by the user on the panel;
a vibrating section for vibrating the panel; and
a vibration control section for controlling a vibration pattern of the vibrating section,
wherein when the user operates the display information on the panel, the display control section controls the movement of the display information based on the position of the display information detected by the display information position detection section, and the vibration control section controls the vibrating section in association with the movement of the display information.

2. The electronic device of claim 1, wherein:
the display information position detection section detects an area of the display information displayed on the display section; and
the vibration control section vibrates the vibrating section when a value of the area becomes less than a predetermined threshold as a result of a movement of a position of at least a portion of the display information.

3. The electronic device of claim 1, wherein:
the display information position detection section detects an area of the display information displayed on the display section;
the vibration control section starts vibrating the vibrating section when the user starts operating the display information; and
the vibration control section changes the vibration of the vibrating section when a value of the area becomes less than a predetermined threshold as a result of a movement of a position of at least a portion of the display information.

4. The electronic device of claim 1, wherein:
the display information position detection section detects a position of a predetermined portion of the display information; and
the vibration control section vibrates the vibrating section when the predetermined portion of the display information has moved past a predetermined position as a result of a movement of a position of at least a portion of the display information.

5. The electronic device of claim 1, wherein:
the display information position detection section detects a position of a predetermined portion of the display information;
the vibration control section starts vibrating the vibrating section when the user starts operating the display information; and
the vibration control section changes the vibration of the vibrating section when the predetermined portion of the display information has moved past a predetermined position as a result of a movement of a position of at least a portion of the display information.

6. The electronic device of claim 1, wherein:
the vibrating section includes a piezoelectric element;
the vibration control section changes a vibration pattern of the vibrating section in response to a movement of a position of at least a portion of the display information.

7. The electronic device of claim 6, wherein the vibration control section changes an amplitude of vibration of the vibrating section in response to the movement of a position of at least a portion of the display information.

8. The electronic device of claim 1, wherein the display section switches the display information to another piece of display information in response to a movement of a position of at least a portion of the display information.

9. The electronic device of claim 8, wherein when a velocity of a slide touch operation by the user on the panel is greater than or equal to a predetermined velocity, the display section switches the display information to the other piece of display information, irrespective of a distance over which at least the portion of the display information has been moved.

10. The electronic device of claim 1, further comprising:
a communication section for communicating with an external device,
wherein the communication section receives data associated with the display information from the external device to the electronic device or outputs the data from the electronic device to the external device, depending on a movement of a position of the display information.

11. A program for instructing an electronic device to perform an operation of vibrating a panel, the program instructing the electronic device to execute the steps of:
detecting a position of display information displayed on the electronic device;
controlling a movement of the display information based on an operation by a user on the panel; and
when the user operates the display information on the panel, controlling the movement of the display information based on the detected position of the display information, and controlling the vibration of the panel in association with the movement of the display information.
